(19) United States
(12) Patent Application Publication
(10) Pub. No.: US 2007/0247294 A1
(43) Pub. Date: Oct. 25, 2007

(54) Method and Apparatus for Monitoring Wheels of a Motor Vehicle

(75) Inventors: Dirk Baader, Hemsbach (DE); Joerg Burghardt, Boeblingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler Chrysler AG, Stuttgart (DE)

(21) Appl. No.: 10/582,480

(22) PCT Filed: Dec. 4, 2004
(86) PCT No.: PCT/EP04/13805

§ 371 Date: Apr. 12, 2007

(30) Foreign Application Priority Data
Dec. 12, 2003 (DE) 103 58 105.7

(51) Int. Cl. B60C 23/04

(52) U.S. Cl. 340/445; 340/438

(57) ABSTRACT

In a method and apparatus for monitoring the wheels of a motor vehicle, each of which comprises at least one tire, the wheels are each provided with a memory and transmitter device for tire-specific data. The data transmitter device interacts with a vehicle mounted receiver device for reading in the tire-specific data. The receiver device is connected to a memory and evaluation unit which makes available the tire-specific data to a further processing functionality of the vehicle.

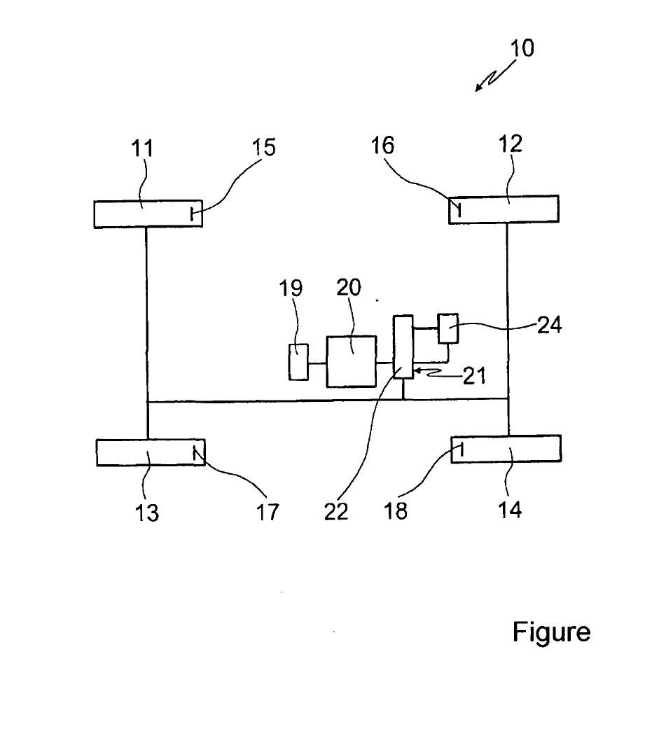

### BACKGROUND AND SUMMARY OF THE INVENTION

This application claims the priority of German patent document 103 58 105.7, filed Dec. 12, 2003 (PCT International Application No. PCT/EP2004/013805, filed Dec. 4, 2004), the disclosure of which is expressly incorporated by reference herein.

The present invention relates to a method and apparatus for detecting and monitoring the wheels of a motor vehicle, each of which has at least one tire.

International patent document WO 95/22467 discloses such a system, which is configured, among other things to monitor the pressure and temperature of a motor vehicle tire. A transponder which is connected to a power supply and to an antenna is arranged in or on the material of the tire so that its current pressure and temperature values can be transmitted wirelessly in response to an interrogation signal from an interrogation device. In addition to pressure and the temperature, tire characteristic data is transferred to the interrogation device.

International patent document WO 99/29522, on the other hand, discloses a motor vehicle tire which has a transponder with an antenna that surrounds the tire in the circumferential direction. The antenna interacts with a receiver device so that data relating to tire pressure and temperature (as well as tire characteristic data) can be transmitted to the receiver device.

In German patent document DE 199 40 06 A1 a tire for a motor vehicle or an aircraft includes a readable and writeable transponder on which data relating to precise identification of the tire on an individual basis is stored, it being possible to read out the data by means of a reading device. Operational data of the tire (for example pressure values and/or temperature values) can also be stored on the transponder and called by means of the reading device.

Finally, International patent document WO 99/52724 discloses a system for measuring motor vehicle tire pressure that includes a transponder which interacts with an external reading/interrogation unit so that tire pressure can be continuously monitored. The interrogation unit, which interacts wirelessly with the transponder, has a display which displays the current pressure value of the respective pressure-monitored tire to a user of the respective motor vehicle.

One object of the present invention is to provide a method and apparatus for the optimized use of tire-specific data.

This and other objects and advantages are achieved by the method and apparatus according to the invention, in which the tire-specific data can be made available to other systems of the motor vehicle by employing further available processing functionality. The electronic data sheet which comprises the tire-specific data can be made available, for example, to an electronic chassis controller and/or an electronic vehicle movement dynamics system of the motor vehicle which can use it to optimize its performance, since the tire-specific data supplies information about the road contact of the wheels. Alternatively, the data sheet can also be made available to a logistic functionality of a vehicle manufacturer or of a service workshop, in particular for assembly monitoring.

The tire-specific data may comprise, for example, a measuring protocol and/or quality protocol, an indication of the position of a particular tire on the motor vehicle, an identification mark of such tire, its type, dimension, design, manufacturer, velocity class and/or load-bearing class, a tire profile, material properties, a production works, a country identifier, a manufacturing date and/or a use-by date. Furthermore, the tire-specific data can also comprise current pressure values and/or temperature values of the respective tire.

Direct measurement of the pressure and temperature in the interior of the tire permits full functionality of a tire pressure-monitoring system. By simultaneously measuring the pressure and temperature it becomes possible to determine the mass air flow rate in a tire by means of what is referred to as an isochoric evaluation. When the tire pressure drops below a minimum value, the further processing functionality preferably carries out an intervention into a driving control system and/or issues a warning to the driver.

The memory and transmitter devices which are preferably arranged on all the wheels of the respective motor vehicle can either be integrated directly into or onto the tire when the tire is manufactured, for example by inclusion in the vulcanization process, or can be arranged on the rim of the respective wheel. In the latter case, the memory and transmitter devices are integrated, for example, in a valve inset.

When a memory and transmitter device is vulcanized into the tire material when the tire is manufactured tire-specific data which is independent of the running time (i.e., data which do not vary while the tire is used) are preferably input into the memory and transmitter device when the tire is manufactured. This has the advantage that, when the tire is produced and mounted, the tire information (which can be read out by the memory and transmitter device, for example by means of a transponder) can be used in the logistic process both at the tire manufacturer's facility and that of the vehicle manufacture. For example, automatic identification can take place during the tire-manufacturing process. Quality data, measurement data and test data can also be stored directly in the tire for later use.

With the method and apparatus according to the invention, it is possible for the vehicle manufacturer to supply automatically, in a defined fashion, a tire from a specific tire manufacturer, of a specific type and of a specific tire dimension, to a specific vehicle. It is also possible to monitor and document the tires of a vehicle automatically. As a result, manual checking is dispensed with. In addition, an automatic deployment concept for a tire material can be implemented.

When a transponder technology is used there is no need for a separate power supply to the memory and transmitter device. The tire-specific data can be interrogated and evaluated at any time by a vehicle-mounted and also by an external receiver device or reading device.

If the memory and transmitter device is arranged on a rim it is possible, preferably when the tire is mounted, for the fitter of the tire to transfer the tire-specific data, which is invariable while the tire is being used, to the data memory device. In this case, the memory, and transmitter device advantageously comprises a rewritable memory so that the respective data memory device can be used again in the same way when a new tire is mounted on the same rim.

The further processing functionality of the system or of the method according to the invention can be configured to influence the driving behavior of the motor vehicle. Such further processing functionality may include, for example, a component of a driving stability functionality, a vehicle movement dynamics functionality or a velocity decreasing functionality. In this way, the driving behavior of the respective motor vehicle can also be influenced as a function, for example, of the type of tire and/or of the tire pressure.

In one specific embodiment of the invention, a velocity limitation is set in order to increase the safety when a gradual loss of pressure in a tire is detected. Of course, the driver may also be informed by means of a visual and/or audible warning signal.

By using the method or apparatus according to the invention, it is possible to transmit overall component-specific information of the tires, including their instantaneous state, to an information system of the vehicle, and thus to minimize the risk of critical driving situations due to tires and optimize the driving behavior of the motor vehicle. This increases the safety of the vehicle occupants. It is thus always possible to inform or warn the driver of a vehicle when there are conditions which can cause a tire to be damaged or destroyed.

It is also possible to use the further processing functionality in such a way that pressure values and temperature values and the running performance of the individual tires, which can be detected by means of a code, are sensed by suitable long-term observations or long-term recordings which are carried out over the running time of the tire or tires. In this manner, the selected velocities can be configured individually in accordance with the temperature loading, which, for example, can lead to an increase in the overall running performance of the tire or tires, given a moderate driving style.

Furthermore, overall running time and durability estimates for the individual tires of the motor vehicle can be by means of the further processing functionality, based on data is stored on the memory and transmitter device of the tire or on the memory and evaluation unit of the motor vehicle, and can represent tire-specific data or driving data.

The further processing functionality can also be configured so that the mounted and/or the permissible tire dimension is displayed on a combination instrument or vehicle display. When a tire dimension that is unacceptable for the particular motor vehicle is detected, a visual and/or audible warning can be issued.

When a specific type of tire (for example a summer tire, a winter tire, what is referred to as an all-season tire or what is called a run flat tire) is detected, the further processing functionality can also activate or deactivate a possibly necessary velocity limiting functionality. This information can also be used in a vehicle movement dynamics system so that characteristics of specific types of tire can be taken into account. Basically, a so-called speed index which is stored on the memory and transmitter device can be converted by the further processing functionality into an automatic limiter function and/or information supplied to the driver about a tire-specific permissible maximum speed.

The further processing functionality can also be configured in such a way that what is referred to as a load index, which is stored on the memory and transmitter device, is converted into a warning function if permissible wheel loads are exceeded, in order to avoid overloading. Information about adapted tire pressures can also always be transmitted to the driver of a vehicle.

Furthermore, the further processing functionality can also issue a warning which informs the driver of a vehicle if designated running distances of a tire or tires are exceeded, based on, for example, of excessive stressing. This can be done taking into account the history of the tire or tires (e.g., times of high thermal and/or mechanical stresses, running distance, pressure history or the like). In this way it is also possible to calculate a residual running distance and display it in a combination instrument or a vehicle display.

Furthermore, the method and apparatus according to the invention make it possible to interrogate further design-related properties of the tire system on a particular motor vehicle, and to monitor them, to detect, for example, mixed use of tires, use of various designs, for example of summer tires and winter tires, simultaneous use of various makes of tire as well as to correct running direction. As a result, specific manufacturer requirements of the mounting of the respective tire are checked.

The memory and transmitter device which is used to store the invariable tire-specific data (for example, type of tire and tire manufacturing date) can be configured as a passive system. (It can be fabricated, for example using transponder technology or chip technology.) Alternatively, it can be an active system which also checks the state of the tire during operation and transfers the data to the receiver device at regular intervals.

When a passive system is used, the invariable tire-specific data is preferably transferred to the corresponding data memory when a tire is manufactured. Given an advantageous embodiment, further data, for example in the form of customer-specific starting data, can be input into this memory after the tire has been mounted on a motor vehicle, so that, for example, a uniquely defined assignment of the positions of the tire on the motor vehicle is possible if corresponding hardware conditions are met. At any later time it is also possible to input current tire state data into a passive system, and the required energy can be transmitted from the motor vehicle to the tire or tires by means of a transponder or the like, via a suitable interface.

If an active system is used, the tire-specific data, which also comprises the pressure and the temperature of the respective tire, is transferred actively, (preferably at regular intervals) to the receiver device or the memory and evaluation unit of the motor vehicle. When transponder technology (i.e., a passive system) is used, the tire-specific data is read out from the memory and transmitter device by means of a corresponding interrogation device.

The various wheels of the motor vehicle are preferably each assigned a code for transmitting the tire-specific data, so that the vehicle-end memory and control unit can correctly assign the respective data items to the individual wheels. This is particularly expedient if the system comprises a central receiver device which can collect the tire-specific data of all the tires of the motor vehicle. When a passive system is used, coding is preferably composed of a number string or the like, while with an active system coding is preferably composed of specific uniquely defined transmission frequencies or else PWM signals.

The memory and evaluation unit can be a central electronic control unit that is present in the motor vehicle for example, in the form of a combination instrument or a central computer unit, irrespective of the system according to the invention. The tire-specific data can be stored and processed in the memory and evaluation unit and subsequently made available (for example, by means of full networking which is frequently present in motor vehicles) to the further processing functionality, such as a component of a vehicle movement dynamics system. As a result, optimum, tire-specific adaptation of the vehicle movement dynamic systems can be achieved. For this it is of course possible for corresponding characteristic diagrams to be stored in the control units of the vehicle movement dynamics system.

The memory and transmitter devices of the individual wheels of a motor vehicle can either interact with a common vehicle-mounted receiver device or with each separate receiver device which is preferably arranged in the respectively assigned wheelhouse.

Other objects, advantages and novel features of the present invention will become apparent from the following detailed description of the invention when considered in conjunction with the accompanying drawings.

### BRIEF DESCRIPTION OF THE DRAWINGS

The single FIGURE of the drawing illustrates an exemplary embodiment of the system according to the invention, in a schematically simplified form.

### DETAILED DESCRIPTION OF THE DRAWINGS

The FIGURE is a basic view of a motor vehicle 10 which is embodied as a passenger car and is equipped with a system for detecting and/or monitoring its wheels (tires 11, 12, 13 and 14). This system comprises, for each of the tires 11 to 14, a memory and transmitter device 15, 16, 17 and 18, which is vulcanized into the tire and which contains characteristic data of the tire 11, 12, 13 and 14. Such data may include, for example, the type of tire, its dimensions, the design of the tire, its manufacturer, its velocity class, its load-bearing class, the type of profile of the tire, the properties of the tire material, the manufacturing date of the tire and its use-by. The memory and transmitter device is configured using transponder technology. Such characteristic data, which is invariable over the running time of the tire 11, 12, 13 and 14, is input into the associated memory and transmitter device 15, 16, 17 and 18, by means of a corresponding transmitter device when the tire is manufactured.

The memory and transmitter devices 15 to 18 of the tires 11 to 14 interact in each case with a pressure and temperature measuring device (not illustrated in more detail here) for the respective tire.

The pressure and temperature values of a tire 11, 12, 13 and 14 as well as its characteristic data each form together a set of tire-specific data. For the use of such data, the memory and transmitter devices 15 to 18 interact with a receiver device 19 by which the tire-specific data of the individual tires 11 to 14 can be read jointly.

The receiver device 19 is connected to a memory and evaluation unit 20 in which tire-specific data received from the individual wheels 11 to 14 can be stored. For further processing, the memory and evaluation unit 20 makes available the tire-specific data to a further processing device 21 which is provided with a further processing functionality, such as a driving stability functionality 22 which is connected to a display 24 that is a component of a combination instrument integrated into a dashboard of the motor vehicle 10.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-14. (canceled)

15. A method for monitoring wheels of a motor vehicle having at least one tire that is provided with a memory and a transmitter device for tire-specific data which is stored in the form of an electronic data sheet; wherein:
the electronic data sheet is read out of the memory and transmitter device by means of a receiver device; and
the electronic data sheet is transmitted to a memory and evaluation unit and made available to a further processing functionality of the vehicle.

16. The method as claimed in claim 15, wherein the further processing functionality is assigned to a logistic functionality of one of a vehicle manufacturer and a service workshop.

17. The method as claimed in claim 15, wherein the further processing functionality comprises one of a driving stability functionality, a velocity decreasing functionality and a chassis control functionality.

18. The method as claimed in claim 15, wherein a measuring and/or quality protocol is assigned to the electronic data sheet.

19. A system for detecting and/or monitoring wheels of a motor vehicle having at least one tire that is provided with a memory and a transmitter device for tire-specific data which is stored in the form of an electronic data sheet, said memory and transmitter device interacting with a receiver device for reading in the tire-specific data; wherein:
the receiver device is connected to a memory and evaluation unit; and
the memory and evaluation unit makes available the tire-specific data to a further processing functionality.

20. The system as claimed in claim 19, wherein the further processing functionality is a component of a driving stability functionality of the motor vehicle.

21. The system as claimed in claim 19, wherein the further processing functionality comprises a velocity decreasing functionality of the motor vehicle.

22. The system as claimed in claim 19, wherein the further processing functionality comprises a chassis control functionality of the motor vehicle.

23. The system as claimed in claim 19, wherein the further processing functionality is a logistic functionality of one of a vehicle manufacturer and a service workshop.

24. The system as claimed in claim 19, wherein each of the wheels comprises a pressure-measuring device for a tire which device is connected to an associated memory and transmitter device.

25. The system as claimed in claim 19, wherein each of the wheels comprises a temperature-measuring device for a tire, which device is connected to an associated memory and transmitter device.

26. The system as claimed in claim 19, wherein:
each of the memory and transmitter devices is provided with tire characteristic data; and
the memory and transmitter devices are each embodied as a rewriteable memory.

27. The system as claimed in claim 19, wherein a one-to-one transmission code is assigned to each of the memory and transmitter devices of the wheels.

28. The system as claimed in claim 19, wherein the tire-specific data comprises at least one of a statement of a position of the tire on the motor vehicle, an identification mark of the tire, a type of tire, a tire dimension, a design, a manufacturer, a velocity class, a load-bearing class, a tire profile, tire material properties, a production works, a country identifier, a manufacturing date and a use-by date.
